(19) United States
(12) Patent Application Publication
(10) Pub. No.: US 2009/0307137 A1
(43) Pub. Date: Dec. 10, 2009

(54) MANAGING PROVENANCE OF DIGITALLY SIGNED DATA IN USER EDITABLE RECORDS

(75) Inventors: Christopher Cameron White, Seattle, WA (US); Michael W. Thomas, Redmond, WA (US); Arthur J. O'Leary, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/136,040

(22) Filed: Jun. 9, 2008

(51) Int. Cl. H04L 9/32; G06Q 50/00

(52) U.S. Cl. 705/51; 705/2

(57) ABSTRACT

A system and method for managing health information. The system may include a server configured to execute an account interface module enabling a user to access a user account, wherein a plurality of healthcare record items are stored on a server, via a user client device. The server may also be configured to execute an upload module that is configured to receive a digitally signed, original version of a healthcare record item from a content supplier, and an editor module configured to enable a user to make a user edit, thereby producing an updated version of the healthcare record item. The server may also be configured to execute a provenance module to determine whether the user edit affects the digitally signed data, and accordingly remove or replace the digital signature, and a download module to download the updated version of the healthcare record item to a content recipient.

### BACKGROUND

Online technologies for the sharing of information offer the promise of increased portability of healthcare data, including patient records. In such systems, it is useful to ensure the source and integrity of such shared information. In contexts outside of healthcare, verifiable digital signatures have been used to provide a mechanism by which recipients of content may verify that the content was signed by a signing party. In the healthcare context, however, the dual goals of ensuring patient control over patient data, and ensuring the integrity of signed content present challenges that current digital signature technologies do not adequately address. One particular challenge is that using current digital signature technologies, any alteration of digitally signed content by an intermediary, such as a patient, would render the integrity of the altered data unverifiable by downstream recipients, potentially frustrating healthcare workflows. As a result, a barrier exists to the widespread adoption of portable patient record systems.

### SUMMARY

A system and method for managing provenance of digitally signed data in user records information are provided. The system may include a server configured to execute an account interface module enabling a user to access a user account, wherein a plurality of healthcare record items are stored on a server. The server may also be configured to execute an upload module that is configured to receive a digitally signed, original version of a healthcare record item from a content supplier, and an editor module configured to enable a user to make a user edit, thereby producing an updated version of the healthcare record item. The server may also be configured to execute a provenance module to determine whether the user edit affects the digitally signed data, and accordingly remove the digital signature or replace the digital signature with a new digital signature passed in via the editor module with the updated version, and a download module to download the updated version of the healthcare record item to a content recipient.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic diagram illustrating an embodiment of a system for managing health information.

FIG. 2 is a diagram illustrating an example use case scenario of the system of FIG. 1.

FIG. 3 is a flowchart of an embodiment of a method for managing health information.

### DETAILED DESCRIPTION

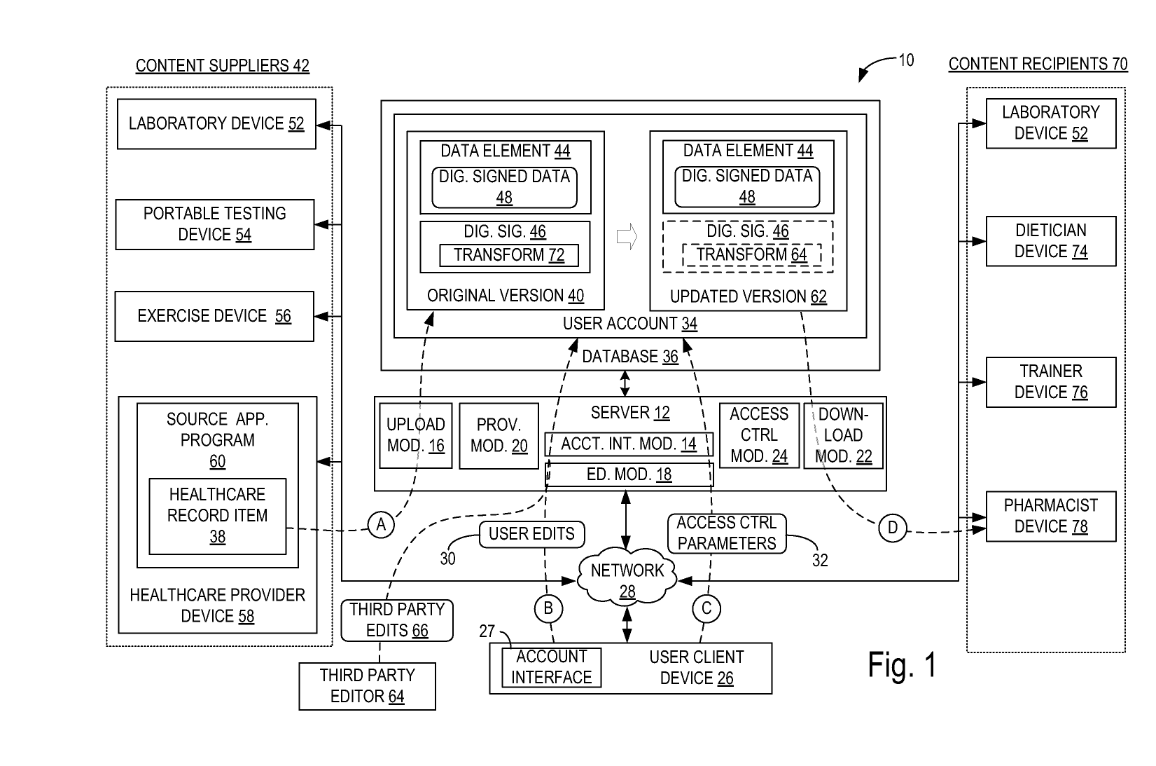

FIG. 1 illustrates a health information management system 10 for managing the provenance of digitally signed data in user editable healthcare records.

As described in detail below, health information management system 10 may include a server 12 configured to execute an account interface module 14 for enabling users to access user accounts on the system, an upload module 16 for receiving digitally signed healthcare record items into the system 10, an editor module 18 for enabling users to update healthcare record items stored in a user account, a provenance module 20 for determining the provenance of digitally signed data in system 10, a download module 22 for downloading healthcare record items to recipients, and an access control module 24 for determining upload, download and other access privileges within system 10. The account interface module, upload module, editor module, and downloading module may be included within an application programming interface (API) of the server 12, while the provenance module may be an executable application program configured to run on server 12, although other configurations are possible.

The account interface module 14 may be configured to serve an account interface 27 to the user client device 26 over network 28, to enable the user to access a user account 34 hosted on a database 36 of the server 12, the account being configured to store a plurality of healthcare record items 38. It will be appreciated that the user client device 26 may be a personal computer of the user or other suitable computing device configured to operate a client program that is configured to communicate with server 12. For example, the user client device may alternatively be a computing device provided by a healthcare provider partner for user usage. The account interface 27 may be configured to exchange various data with server 12, including queries to access healthcare record items 38 stored in user account 34, user edits 30 to update records in user account 34, and user-specified access control parameters 32, by which the user may designate which content suppliers 42, content recipients 70, or other authorized users may access and/or update information in user account 34, as discussed below.

The upload module 16 may be configured to receive an original version 40 of healthcare record item 38 from a content supplier 42. It will be appreciated that the term original refers to a first version of the healthcare record item 38 uploaded to the system relative to one or more later updated versions, and does not necessarily refer to content that is an original work of authorship by the content supplier.

The healthcare record item 38 may include a plurality of data elements 44 configured to hold various types of health information. To verify the source and integrity of the health information, the healthcare record item 38 may include a digital signature 46 of the content supplier 42 that is associated with digitally signed data 48 in the healthcare record item 38. The digital signature 46 may include an associated digital certificate that may be verifiable via a third party authority, referred to as a root authority.

The content supplier 42 may be a content supplier device configured to digitally sign and upload data to server 12. The content supplier device may be an application specific device such as a laboratory device 52, a portable testing device 54, an exercise device 56 (e.g., a treadmill or heart rate monitor), or a general purpose computing device such as a healthcare provider computing device 58. Additionally, the content supplier device may include a combination of such application specific devices and computing devices which together operate to digitally sign and upload data to server 12. A source application program 60 may be executed on each of the content supplier devices, to append the digital signature 46 of the content supplier 42 onto the appropriate data element 44 of the healthcare record item 38, thereby generating the associated digitally signed data 48. Alternatively, data may be gathered by an application specific device, and transferred to a general purpose computing device for digital signature and upload by the source application program 60.

As illustrated at C, the access control module 24 may be configured to receive user settings for access control parameters 32 from the user client device 26, which may specify therein whether a content supplier 42 has authority to upload a healthcare record item 38 to the user account, and whether a content recipient 70 has authority to download the healthcare record item 38 to the user account. The upload module 16 or download module 22 may be respectively configured to confirm that the content supplier 42 or content recipient 70 is authorized to upload or download the healthcare record item 38, prior to upload or download.

As illustrated at A, the content supplier 42 may provide a healthcare record item 38 for upload into the user account 34. The healthcare record item 38 may be received and accepted by the upload module 16 upon confirmation that the content supplier is authorized to upload the healthcare record item 38, based on the access control parameters 32 specified by the user in the access control module 24. The upload module 16 may further recognize that one or more of the individual data elements 44 in the healthcare record item 38 are digitally signed data 48 based on the presence of an attached digital signature 46.

As illustrated at B, the editor module 18 may be configured to enable the user to make a user edit 30 to the healthcare record item 38, to thereby produce an updated version 62 of the healthcare record item 38. In some cases, a new digital signature of the user may be received via the editor module, for possible inclusion in the updated version. In the depicted embodiment the editor module 18 is served by server 12 for execution on the user client device 26. However, it will be appreciated that in alternative embodiments, the editor module 18 may be an application program stored on the user client device or an editor computing device, for example. In some scenarios, multiple updates may be made to the healthcare record item 38. Thus, it will be appreciated that the updated version 62 of the healthcare record item 38 may be, for example, a first updated version 63 of the healthcare record item 38. The access control module 24 may be further configured to receive an access control parameter 32 specifying that an authorized third party editor 64 is authorized to edit the healthcare record item 38. Accordingly, the editor module 18 may be further configured to receive third party edits 66 annotated with a digital signature 46 of the authorized third party editor 64 in the healthcare record item 38, to thereby produce a second updated version 68 of the healthcare record item 38. The third party editor 64 may be, for example, an alternate authorized user, a second content supplier 42, or a second content recipient 70 that have been specified by the user as being authorized to access and edit the healthcare record item in the user account 34, as via access control parameters 32.

The provenance module 20 may be configured to determine whether the user edit 30 affects a portion of the digitally signed data 48 of the updated version 62 of the healthcare record item 38. Accordingly, the provenance module 20 may remove the digital signature 46 in the updated version 62 of the healthcare record item 38 or replace the digital signature with a new digital signature passed in via the editor module with the updated version, if the user edit 30 affects the digitally signed portion of the healthcare record item 38. One example of user edits that typically do not affect a digitally signed portion of the healthcare record item 38 is the addition of metadata such as user comments to a healthcare record item 38 by the user. In such a case, the provenance module 20 may be configured to detect that the authorized user edits 30 performed by the authorized user and/or the third party editor 64 do not affect a portion of the digitally signed data 48 of the healthcare record item 38, but rather affect a metadata portion of the healthcare record item 38. In this case, the provenance module 20 may be configured to leave the digital signature 46 intact, rather than removing it.

It will be appreciated that one or more other parties such as third party editors 64 may download and digitally sign the updated version 62 of the healthcare record item 38. Thus, the provenance module may be further configured to verify one or more additional digital signatures 46 in the updated version 62 of the healthcare record item 38 that that have been added by other parties.

Further, where updates are made by a third party editor 64, the provenance module 20 may be further configured to determine whether the third party edits 66 affect a portion the digitally signed data 48 of the first updated version 63 of the healthcare record item 38. Accordingly, the provenance module 20 may remove a corresponding digital signature 46 in the first updated version 63 of the healthcare record item 38 if the third party edits 66 affect the digitally signed portion of the healthcare record item 38. Thus, a third party may both digitally sign the updated version 62 with its own new digital signature, and make edits to the updated version that result in the removal of an existing digital signature in the updated version.

The provenance module 20 may be configured to determine the digitally signed portion of the healthcare record item 38 by referencing a transform 72 associated with the digital signature 46. In one example, the healthcare record item 38 may be in an extensible mark-up language (XML) format and the transform 72 may be in an extensible style sheet transformation (XLST) format. In the above described manner, the digital signature 46 attached to the digitally signed data 48 may attest to the origin and authenticity of the data element 44, even when the data in the data element 44 is subject to update by the user and/or authorized third parties, since the digital signature 46 itself is removed when such updates are made.

In order to determine the validity of a digital signature 46 of a third party editor 64, prior to download, the provenance module 20 may be further configured to verify a validity of a digital certificate associated with an editor-specific digital signature 46 based on an accreditation and an assigned validity period of the digital certificate by the third party authority 50.

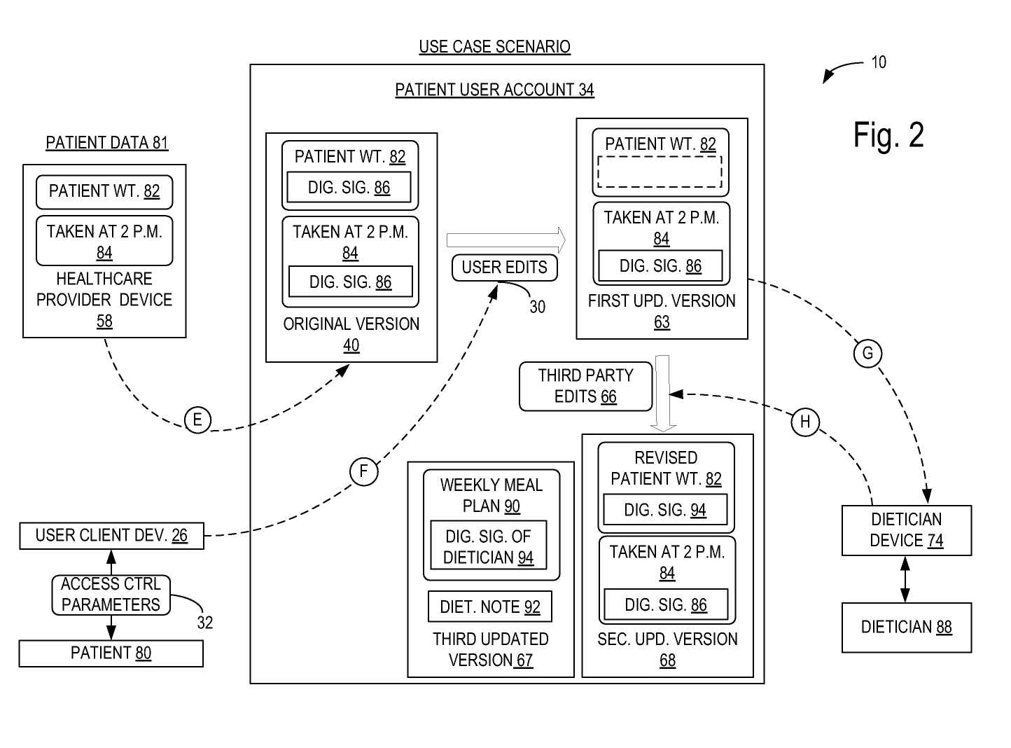

As illustrated at D, the download module 22 may be configured to download the healthcare record item 38 to a content recipient 70. Where multiple versions of the healthcare record item 38 exist, a download version may be selected based on user specified or programmatic rules of the download module 22. For example, as illustrated in FIG. 2, a current version may be selected for download, which may be the original version 40 if no updates have been made, or may be an updated version 62 of the healthcare record item 38, such as a first updated version 63 or a second updated version 68, with the digital signature 46 removed. Prior to download, the download module 22 confirms that the content recipient 70 is authorized to download the healthcare record item 38, based on the access control parameters 32 specified by the user in the access control module 24.

Continuing with FIG. 1, it will be appreciated that the content recipient 70 may be a content recipient device such as an application specific device or a general purpose computing device. The application specific content recipient device may, for example, be a laboratory device 52, a dietician device 74, a trainer device 76, a pharmacist device 78, or other suitable device configured to receive a healthcare record item 38 from server 12. When an updated version 62 is selected for download, the access control parameters 32 may be further configured to specify that the original version 40 of the healthcare record item 38 is also to be downloaded to the content recipient 70 along and accordingly, the download module 22 may download the original version 40 to the content recipient 70, along with an updated version 62, such as the first updated version 63 or the second updated version 68, as illustrated in FIG. 2. In this manner, the content recipient 70 will receive a healthcare record item 38 that includes digital signature 46 that applies only to digitally signed data that has not been updated by an intervening party such as the user or an authorized third party editor 64, and thus the content recipient 70 can verify the provenance of the digitally signed data within the healthcare record item 38.

To further clarify the concepts introduced in FIG. 1, an example use case scenario is depicted in FIG. 2. In this example, the user may be a patient 80 who undergoes regular weight measurements, and the healthcare record item 38 may be patient data regarding a patient weight 82 of the patient 80. A weight of the patient 80 may be determined by a healthcare provider (which may be a family member caring for the user in the home, for example) and inputted into a healthcare provider computing device 58 during a routine check at 2 pm.

The access control parameters 32 specified by the patient 80 may indicate that the healthcare provider is an authorized content supplier 42. Accordingly, as depicted at E, the patient data 81 pertaining to the weight taken may be uploaded as a healthcare record item 38 by the healthcare provider, via the healthcare provider computing device 58, and saved in the patient's user account 34. The uploaded patient data 81 may include a plurality of data elements pertaining to the patient weight 82 and a time-specific data element 84 pertaining to the time the weight was taken. The uploaded healthcare record item 38 may include a healthcare provider-specific digital signature 86. At a later time, the patient 80 may decide that the weight taken did not correctly reflect the actual weight of the patient 80. For example, the patient 80 may remember that he was wearing a heavy piece of clothing when the weight measurement was taken, and may decide that the actual patient weight 82 was about 4 pounds lower. Accordingly, as depicted at F, the patient 80 may perform a user edit 30 to edit the data element pertaining to the patient weight 82 in the healthcare record item 38 to reflect what the patient 80 feels reflects a more accurate estimate of the patient's weight 82. Consequently, a first updated version 63 of the healthcare record item 38 may be generated, wherein the healthcare provider-specific digital signature 86 attached to the patient weight 82 data element may be removed.

The access control parameters 32 specified by the patient 80 may further indicate that the patient's dietician 88 is an authorized content recipient 70. Accordingly, at a later time, as depicted at G, the healthcare record item 38 may be requested by the patient's dietician 88 in order to appropriately assemble a weekly meal plan 90 for the patient 80. The first updated version 63 of the healthcare record item 38 may be downloaded by the dietician 88 via dietician device 74, as depicted at G. The dietician 88 may note the lack of a healthcare provider-specific digital signature 86 on the patient weight 82 data element and ask the patient 80 for clarification regarding the removal of the digital signature 46 from the healthcare record item 38 prior to setting up the weekly meal plan 90. Alternatively, the dietician 88 may request access to the first updated version 63 and the original version 40 of the healthcare record item 38. The dietician 88 may optionally confer with the patient's healthcare provider to clarify, or verify, the reason for the discrepancy.

Since the weight of the patient 80, may be considered in the assembly of the weekly meal plan 90 by the patient's dietician 88, or an exercise plan by the patient's trainer, discrepancies between them may significantly alter a patient's weekly meal plan 90, or exercise regimen, which may consequently affect the patient's health. The dietician 88 may be authorized by the patient 80 to act as a third party editor 64. Accordingly, as depicted at H, the dietician 88 may be authorized to access and generate third party edits 66 to the patient's healthcare record item 38. The dietician 88 may confer with the patient 80 and/or patient's healthcare provider and may agree with the patient 80 regarding a revised weight and accordingly may edit the patient weight 82 data element of the first updated version 63 of the healthcare record item 38 to indicate a revised weight 85.

The dietician 88 may further add a dietician note 92, for the benefit of an alternate second content recipient 70. The second content recipient 70 may be the patient's trainer accessing the account prior to setting up an exercise plan, or the patient's original healthcare provider accessing the patient's user account 34 before the subsequent routine check-up. The dietician's note 92 may specify that the weekly meal plan 90 assembled for the patient 80 is based on the revised data revised weight 85 element 84. The third party edits 66 specified by the dietician 88 may be received via the dietician device 74 and a dietician-specific digital signature 94 may be attached to the revised weight 85 data element, thereby generating a second updated version 68 of the healthcare record item 38. In this way, the patient 80 maintains control over the contents of the healthcare information stored on the user account 34, while the content recipient 70, herein the dietician 88, is able to obtain the healthcare record item 38 and be cognizant of discrepancies between the uploaded original version 40 and the downloaded first updated version 63 and/or second updated version 68, respectively, of the healthcare record item 38.

Further, it will be appreciated that in another use case scenario, the patient 80 may not change the patient weight 82 as described above, but instead may attach metadata including a user comment to the healthcare record item 38, wherein the patient 80 may note that he was wearing a heavy article of clothing at the time of weight measurement, as an annotation of the circumstances. In such a scenario, since the comment does not affect any of the digitally signed data elements of the healthcare record item 38, but merely reflects new metadata, the provenance module 20 is configured to leave the digital signature 46 intact, and accordingly, a third updated version 67 of the healthcare record item 38 may be created including the added metadata and the intact digital signature, as shown in FIG. 2.

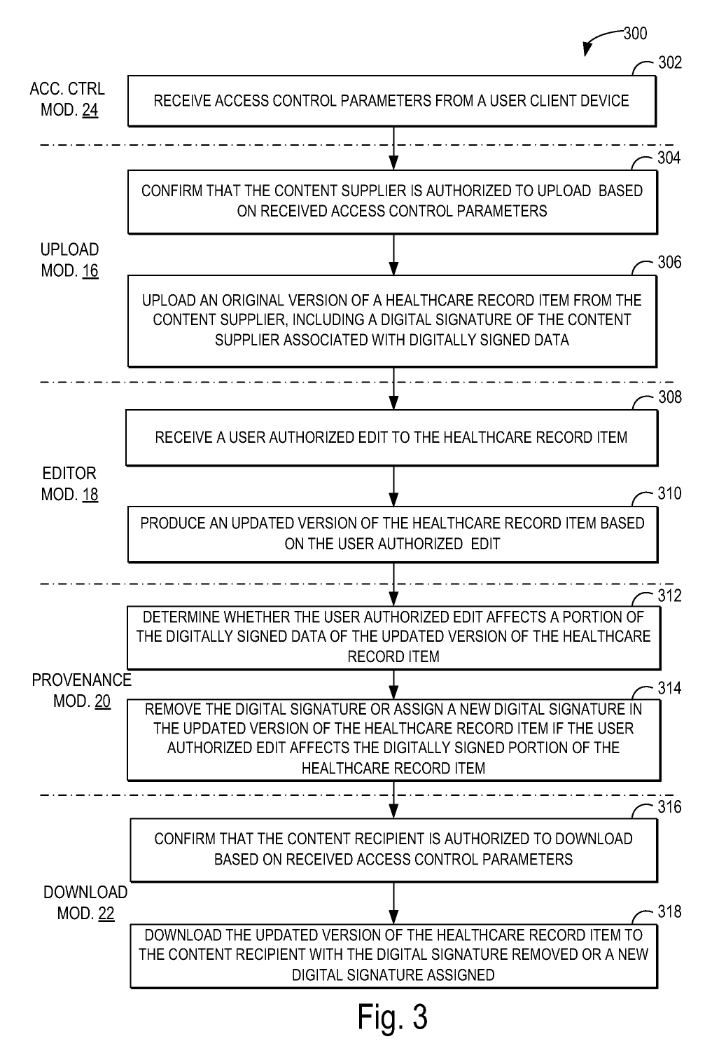

FIG. 3 illustrates an embodiment of a method 300 to manage health information. The method 300 may be implemented using the hardware and software of the systems described above, or via other suitable hardware and software. Specifically, the method 300 allows a user to manage a user account hosted on a server, the user account being configured to store a plurality of healthcare record items.

The method 300 may include, at 302, receiving access control parameters from a user client device. The access control parameters may be received, for example, by an access control module configured on a server. The access control parameters may specify the authority of a content supplier uploading a healthcare record item, a content recipient downloading a healthcare record item, and a third party editor accessing the user account and further performing third party edits to the healthcare record item.

The method 300 may further include, at 304, confirming that the content supplier is authorized to upload based on received access control parameters. The method 300 may further include, at 306, upon confirming that the content supplier is authorized, uploading an original version of a healthcare record item from the content supplier. The healthcare record item that is uploaded may include a digital signature of the content supplier that is associated with digitally signed data in the healthcare record item. The digital signature may have an associated digital certificate that may be verifiable via a third party authority, referred to as a root authority. The content supplier may be a content supplier device such as a healthcare provider computing device, an exercise device, a portable testing device, a laboratory device, or other suitable computer enabled device configured to communicate digitally signed data with the server. It will be appreciated that confirming the content supplier and uploading the original version may be accomplished by an upload module executed on the server, in cooperation with the access control module.

At 308, the method 300 may include, receiving a user authorized edit to the healthcare record item. It will be appreciated that the user authorized edit may include a user edit performed by the user or a third party edit performed by a third party editor authorized by the user via appropriate access control parameters. In some cases, a new digital signature associated with the user authorized edit may be received from the party making the user authorize edit. Further, at 310, the method 300 may include, producing an updated version of the healthcare record item based on the user authorized edit. This may be performed, for example, by an editor module executed on the server.

In some instances multiple user authorized edits may be received for a healthcare record item, from the same or different entities. For example, the updated version of the healthcare record item produced at 310 may be a first updated version of the healthcare record item that has been edited by the user, and the access control parameters may specify a third party editor authorized to make third party edits to the healthcare record item. Further, the method may further include, receiving additional user authorized edits, from the authorized third party editor, and annotating the third party edits in the healthcare record item with an editor-specific digital signature of the editor, to thereby produce a second updated version of the healthcare record item. The validity of the editor-specific digital signature may be verified based on an accreditation and an assigned validity period of the digital certificate associated with the digital signature by the third party authority.

At 312, the method 300 may include, determining whether the user authorized edit affects a portion of the digitally signed data of the updated version of the healthcare record item. At 314, the method 300 may further include, removing the digital signature in the updated version of the healthcare record item or replacing the digital signature with a new digital signature passed in via the editor module with the updated version if it is determined that the user authorized edit affects the digitally signed portion of the healthcare record item. This may be performed, for example, by a provenance module executed on the server.

In situations where a third party editor has performed third party edits as described above, the method 300 may further include determining whether the third party edits affect a portion of the digitally signed data of the first updated version of the healthcare record item, and accordingly, removing a corresponding digital signature in the first updated version of the healthcare record item if the third party edits affect the digitally signed portion of the healthcare record item.

As described above, the provenance module may determine whether the user authorized edit affects a portion of the digitally signed data of the updated version of the healthcare record item by referencing a transform associated with the digital signature. In one example, the healthcare record item may be in an XML format while the transform may be in XLST format.

At 316, the method may include, downloading the updated version of the healthcare record item to a content recipient upon confirming that the content recipient is authorized to download based on received access control parameters. At 318, the method may include, downloading the first updated version, or second updated version of the healthcare record item to a content recipient, with the digital signature removed. The content recipient may be a content recipient device such as a pharmacist device, a dietician device, a trainer device, a laboratory device, or other suitable computing device configured to receive digitally signed data with the server. It will be appreciated that the downloading may be performed by a download module also executed on the server.

The above described systems and methods may be implemented to enable a user to retain the ability to edit user healthcare records in a user account of an online health information management system, while also providing a content recipient of the user healthcare records a mechanism for verifying the provenance of the data contained in the user healthcare records as originating from a specified content supplier.

It will be appreciated that the above described systems and methods have application in systems and methods for managing information generally, and thus, the health care record items described above may be general data records, and the content suppliers and content recipients may be suppliers and recipients of content generally, and need not be restricted to the health care field.

It will be appreciated that the computing devices described herein may be any suitable computing device configured to execute the programs described herein. For example, the computing devices may be a mainframe computer, personal computer, laptop computer, portable data assistant (PDA), computer-enabled wireless telephone, networked computing device, or other suitable computing device, and may be connected to each other via computer networks, such as the Internet. These computing devices typically include a processor and associated volatile and non-volatile memory, and are configured to execute programs stored in non-volatile memory using portions of volatile memory and the processor. As used herein, the term “program” refers to software or firmware components that may be executed by, or utilized by, one or more computing devices described herein, and is meant to encompass individual or groups of executable files, data files, libraries, drivers, scripts, database records, etc. It will be appreciated that computer-readable media may be provided having program instructions stored thereon, which upon execution by a computing device, cause the computing device to execute the methods described above and cause operation of the systems described above.

It should be understood that the embodiments herein are illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A health information management system, comprising a server configured to execute:
an account interface module configured to serve an account interface to a user client device, the account interface being configured to enable a user to access a user account hosted on the server, the account being configured to store a plurality of healthcare record items;
an upload module configured to receive an original version of a healthcare record item from a content supplier, the healthcare record item including a digital signature of the content supplier that is associated with digitally signed data in the healthcare record item, the digital signature having an associated digital certificate, the digital certificate being verifiable via a third party authority;
an editor module configured to enable a user to make a user edit to the healthcare record item, to thereby produce an updated version of the healthcare record item;
a provenance module configured to determine whether the user edit affects a portion of the digitally signed data of the updated version of the healthcare record item, and to remove the digital signature in the updated version of the healthcare record item or replace the digital signature with a new digital signature passed in via the editor module with the updated version, if the user edit affects the digitally signed portion of the healthcare record item; and
a download module configured to download the updated version of the healthcare record item to a content recipient, with the digital signature removed.

2. The system of claim 1, wherein the provenance module is further configured to verify one or more additional digital signatures in the updated version of the healthcare record item that that have been added by other parties.

3. The system of claim 2, wherein the server is further configured to execute:
an access control module configured to receive access control parameters from a user client device;
wherein the upload and download module are respectively configured to confirm that the content supplier or recipient is authorized to upload and download the updated version of the healthcare record item.

4. The system of claim 2, wherein the access control parameters are configured to specify that the original version of the healthcare record item is also to be downloaded to the content recipient and the download module is configured to download the original version to the content recipient.

5. The system of claim 2, wherein the provenance module determines the digitally signed portion of the healthcare record item by referencing a transform associated with the digital signature.

6. The system of claim 5, wherein the healthcare record item is in XML format and the transform is in XLST format.

7. The system of claim 5,
wherein the updated version is a first updated version of the healthcare record item;
wherein the access control module is further configured to receive an access control parameter specifying that an authorized third party editor is authorized to edit the healthcare record item;
wherein the editor module is configured to receive third party edits from the authorized third party and include the third party edits annotated with a digital signature of the authorized third party editor in the healthcare record item, to thereby produce a second updated version of the healthcare record item; and
wherein the provenance module is configured to determine whether the third party edits affect a portion of the digitally signed data of the first updated version of the healthcare record item, and to remove a corresponding digital signature in the second updated version of the healthcare record item if the third party edits affect the digitally signed portion of the healthcare record item.

8. The system of claim 7, wherein prior to download, the provenance module is further configured to verify a validity of a digital certificate associated with an editor-specific digital signature based on an accreditation and a validity period of the digital certificate assigned by the third party authority.

9. The system of claim 8, wherein the content supplier is a content supplier device selected from the group consisting of a healthcare provider computing device, an exercise device, a portable testing device and a laboratory device.

10. The system of claim 8, wherein the content recipient is a content recipient device selected from the group consisting of a pharmacist device, a dietician device, a trainer device and a laboratory device.

11. A method for managing health information, the method comprising:
uploading an original version of a healthcare record item from a content supplier, the healthcare record item including a digital signature of the content supplier that is associated with digitally signed data in the healthcare record item, the digital signature having an associated a digital certificate, the digital certificate being verifiable via a third party authority;
receiving a user authorized edit to the healthcare record item;
producing an updated version of the healthcare record item based on the user authorized edit;
determining whether the user authorized edit affects a portion of the digitally signed data of the original version of the healthcare record item;
removing the digital signature in the updated version of the healthcare record item or replacing the digital signature with a new digital signature corresponding with the user authorized edit, if the user authorized edit affects the digitally signed portion of the healthcare record item; and
downloading the updated version of the healthcare record item to a content recipient, with the digital signature removed.

12. The system of claim 1, further comprising verifying one or more additional digital signatures in the updated version of the healthcare record item that that have been added by other parties.

13. The method of claim 12 further comprising:
receiving access control parameters from a user client device;
uploading the original version of the healthcare record item from the content supplier upon confirming that the content supplier is authorized to upload based on the received access control parameters; and
downloading the updated version of the healthcare record item to the content recipient upon confirming that the content recipient is authorized to download based on received access control parameters.

14. The method of claim 13 further comprising downloading the original version of the healthcare record item to the content recipient when the access control parameters are configured to specify that the original version of the healthcare record item is also to be downloaded to the content recipient.

15. The method of claim 11 wherein determining whether the user authorized edit affects the digitally signed data of the updated version of the healthcare record item includes referencing a transform associated with the digital signature.

16. The method of claim 15 wherein the health care record item is in XML format and the transform is in XLST format.

17. The method of claim 11,
wherein the updated version is a first updated version of the healthcare record item; and
the method further comprising:
receiving third party edits from an authorized third party editor;
annotating the third party edits in the healthcare record item with an editor-specific digital signature of the editor, to thereby produce a second updated version of the healthcare record item;
determining whether the third party edits affect a portion of the digitally signed data of the first updated version of the healthcare record item; and
removing a corresponding digital signature in the second updated version of the healthcare record item or replacing the corresponding digital signature in the second updated version with a new digital signature of the authorized third party editor, if the third party edits affect the digitally signed portion of the healthcare record item in the first updated version.

18. The method of claim 17 further comprising verifying a validity of a digital certificate associated with an editor-specific digital signature based on an accreditation and an assigned validity period of the digital certificate by the third party authority.

19. The method of claim 18,
wherein the content supplier is a content supplier device selected from the group consisting of a healthcare provider computing device, an exercise device, a portable testing device and a laboratory device; and wherein the content recipient is a content recipient device selected from the group consisting of a pharmacist device, a dietician device, a trainer device and a laboratory device.

20. A method for managing user controlled information, the method comprising:
uploading an original version of a record item from a content supplier, the record item including a digital signature of the content supplier that is associated with digitally signed data in the record item, the digital signature having an associated digital certificate, the digital certificate being verifiable via a third party authority;
receiving a user authorized edit to the record item;
producing an updated version of the record item based on the user authorized edit;
determining whether the user authorized edit affects a portion of the digitally signed data of the updated version of the record item;
removing the digital signature in the updated version of the record item or replacing the digital signature with a new digital signature passed in via the editor module with the updated version, if the user authorized edit affects the digitally signed portion of the record item; and
downloading the updated version of the record item to a content recipient, with the digital signature removed.
